(19) United States
(12) Patent Application Publication
(10) Pub. No.: US 2017/0017987 A1
(43) Pub. Date: Jan. 19, 2017

(54) PROMOTIONAL VIDEO COMPETITION SYSTEMS AND METHODS

(71) Applicant: Quasar Blu, LLC, Atlanta, GA (US)

(72) Inventor: Mark Thomas, Atlanta, GA (US)

(21) Appl. No.: 14/799,326

(22) Filed: Jul. 14, 2015

(51) Int. Cl. G06Q 30/02; H04N 5/76; G06Q 50/00; H04N 7/18

(52) U.S. Cl. CPC G06Q 30/0243; H04N 7/18; G06Q 30/0276; G06Q 30/0251; G06Q 30/0218; H04N 5/76; G06Q 50/01

(57) ABSTRACT

A system and method for incentivizing bartenders and other individuals to promote a particular brand of alcohol by creating a video competition. The system receives instructions to implement a video competition and notifies a plurality of individuals of the video competition. The participants to the video competition each create a video showing the individual preparing a particular alcoholic beverage. The video is created using a video production application that simplifies the video production process by providing guidelines for filming the video, automatically speeding up one or more portions of the recorded video, and allowing the user to easily edit the video. Videos created using the video production application may also be used as a part of an electronic cocktail menu. The system may identify prize winners for the video competition and transfers prizes to the winners, for example, electronically.

### BACKGROUND

Producers of different products require varying levels of advertising to properly promote their products. Although traditional forms of advertising, such as television and radio advertisements, may provide sufficient means of promoting some types of products, other types of products are more effectively promoted through less formal and/or less traditional types of advertisements. For example, alcoholic beverages and mixed drinks are often most effectively promoted through word-of-mouth recommendations from bartenders. However, it can be challenging to generate such recommendations. Accordingly, there is currently a need for improved systems and methods for promoting products such as alcoholic beverages and mixed drinks.

### SUMMARY OF THE VARIOUS EMBODIMENTS

In general, in various embodiments, a computer system is adapted for incentivizing bartenders and other individuals to promote a particular brand of alcohol via a promotional video competition, the system comprising at least one processor and memory: (1) receiving instructions to implement a video competition that is open to both bartenders and non-bartenders; (2) in response to receiving the instructions, notifying a plurality of individuals of the competition, the plurality of individuals comprising both a plurality of bartenders and a plurality of non-bartenders; (3) receiving, from each of the plurality of individuals, a respective video in which the individual is shown preparing a particular alcoholic beverage that includes the particular brand of alcohol; (4) identifying one or more prize winners of the competition based, at least in part, on a predetermined set of rules; and (5) at least partially in response to identifying the one or more prize winners, transferring a respective prize to each respective one of the prize winners.

In general, in various embodiments, a computer system for promoting a particular brand of alcohol via an electronic cocktail menu is configured to: (1) receive a first video showing a bartender preparing a first particular alcoholic beverage; (2) receive a second video showing a bartender preparing a second particular alcoholic beverage; (3) receive a third video showing a bartender preparing a third particular alcoholic beverage; and (4) assemble the first, second, and third videos into the electronic cocktail menu that can be played on a portable electronic device and used by a customer to selectively view the first, second, and third videos.

A non-transitory computer-readable medium for allowing a user to produce one or more videos in a simplified manner stores computer-executable instructions for: (1) providing each of a plurality of individuals with access to video production software that facilitates the production of a finalized video, via a handheld computing device; (2) receiving, from each of the plurality of individuals, a respective video in which the individual is shown preparing a particular alcoholic beverage that includes a particular brand of alcohol; (3) preparing an accelerated speed replay of raw video footage, taken using the handheld computing device; and (4) after receiving the respective video in which the individual is shown preparing a particular alcoholic beverage that includes a particular brand of alcohol and preparing an accelerated speed replay of raw video footage, generating the finalized video.

A method for scoring a promotional video competition, the method comprising: (1) receiving data regarding a first video showing a bartender preparing a first particular alcoholic beverage; (2) receiving data regarding a second video showing a bartender preparing a second particular alcoholic beverage; (3) comparing the data for the first video with the data for the second video; and (4) at least partially based on the comparison between the data for the first video and the data for the second video, identifying one or more prize winners of the competition. In various embodiments, the respective data for each of the first video and the second video comprises a number of impressions and/or potential impressions for the respective video.

### BRIEF DESCRIPTION OF THE DRAWINGS

Various embodiments of product promotion systems and methods are described below. In the course of this description, reference will be made to the accompanying drawings, which are not necessarily drawn to scale and wherein:

FIG. 1 is a block diagram of a promotional video competition system in accordance with an embodiment of the present system;

FIG. 2 is a block diagram of the promotional video competition server of FIG. 1;

FIG. 3 illustrates a flowchart that generally illustrates various steps executed by a promotional video competition module according to a particular embodiment; and

FIGS. 4-21 are exemplary screen displays of the system according to various embodiments.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In general, a system and method, according to various embodiments, is adapted for incentivizing bartenders and other individuals to promote a particular brand of alcohol, mixed drink, or other product via a promotional video competition. The system, as a whole, may, for example, promote mass organic marketing of a particular brand of alcohol (or other product) by providing a computer platform that allows bartenders and other individuals to promote themselves, their employer (e.g., a particular bar), and/or a particular brand of alcohol through a single activity. The system allows an alcoholic beverage producer (or another entity, such as distributor, or a producer of a type of product other than an alcoholic beverage), to initiate a marketing campaign that includes a video competition that is open to the public. In response to the marketing campaign being initiated, the system may: (1) notify a plurality of individuals (e.g., bartenders and non-bartenders) of the competition (e.g., via suitable advertising channels); (2) facilitate entry of the individuals into the competition; (3) provide a video production application that allows each of the individuals to easily produce a video for entry into the video competition; (4) receive a completed video from each of the individuals; (5) at least substantially automatically analyze the quality, content, and/or popularity of each of the received videos; and (6) based, at least in part, on this analysis, determine the outcome of the competition based on a predetermined set of rules. In various embodiments, the marketing campaign allows the plurality of individuals to determine the style, personality, messaging, language, artistic choices, target audience, timing, and/or creative content for the video competition. The system may also collect data about the one or more viewers of the video such as the viewer's: gender, age, geographic location, interests, etc. The predetermined set of rules may, for example, specify one or more particular alcoholic beverages to be prepared in the video, the environment in which the video is to be filmed (e.g., a public bar), the criteria by which winners of the competition will be determined, etc. The system may also facilitate the transfer of one or more prizes (e.g., cash prizes) to one or more winners of the video competition. In particular embodiments, the system may be adapted to award prizes to a relatively large percentage of entrants into the competition (e.g., more than about 40%, 50%, or 60% of the entrants). In various embodiments, the system may be adapted to facilitate the electronic transfer of the prizes to the individuals. For example, the system may facilitate the payment of cash prizes to the respective individuals via a suitable electronic payment system, such as PayPal, Google Wallet, Venmo, etc. Although discussed in the context promoting a particular brand of alcohol, various embodiments of the system may be used to promote any other suitable product or service.

In various embodiments, the system may be adapted to provide a simplified video production and editing system for filming and editing videos on a handheld computing device or other computing device. This video production system may, for example, implement various techniques for simplifying the process of: (1) inserting formatted text into video; (2) adjusting the final playback speed of the video (e.g., speed up, selectively slow down); (3) adding a voiceover to video footage that has been recorded; (4) adding additional information, such as the ingredients of a beverage that an individual is shown preparing in the video; and (5) preparing a finalized version of the video based on the above.

In particular embodiments, the system may be adapted for facilitating the development and maintenance of an electronic cocktail menu (which may, for example, be electronically searchable—e.g., using one or more keywords) that includes a video of each drink on the menu being prepared. This may, for example: (1) help promote the various drinks on the cocktail menu; (2) help customers and bar/restaurant employees better understand the drinks on the menu; and (3) help in training bartenders to prepare the drinks on the menu properly. Thus, the electronic cocktail menu may help: (1) to educate bartenders and other restaurant employees; (2) to better inform customers about drinks that are available for purchase and/or about the bartender who will be preparing the drinks; and/or (3) to make finding a drink on the menu easier than finding a drink on a traditional paper menu that is not electronically searchable.

In various embodiments, the system is adapted to receive multiple, brief videos that each show a bartender preparing a particular alcoholic beverage that is on a restaurant's cocktail menu, where each video shows the particular alcoholic beverage's ingredients and the way that the particular alcoholic beverage is prepared. The system may also be adapted to use the videos to generate an electronic cocktail menu. The system may provide access to the electronic cocktail menu to customers and bar/restaurant employees (e.g., via a suitable computing device, such as a mobile computing device—e.g., a smartphone or tablet computer).

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of Internet-implemented computer software. Any suitable computer-readable storage medium may be utilized including, for example, hard disks, thumb drives, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any suitable type of network, including but not limited to: (1) a local area network (LAN); (2) a wide area network (WAN); and/or (3) a cellular network. It should be understood that a particular computer's connection to the network may be made via an external computer (for example, by connecting to the internet via a “hotspot” provided by a portable wireless device).

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

Example System Architecture

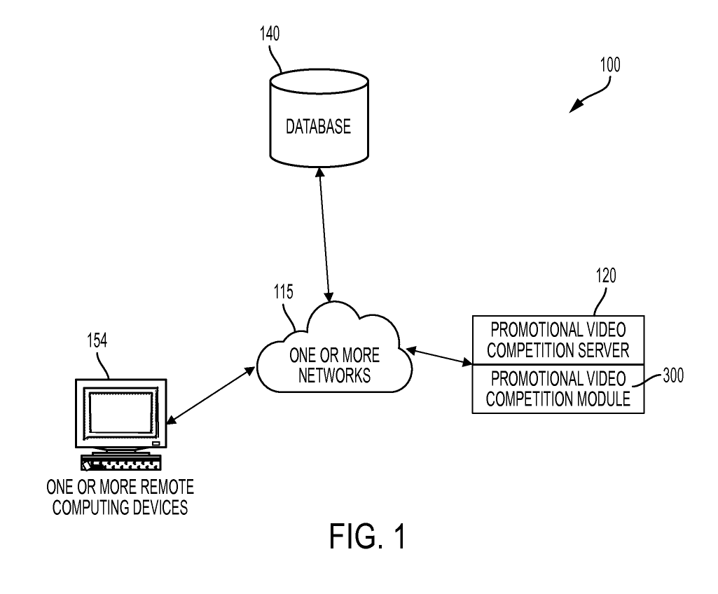

FIG. 1 is a block diagram of a promotional video competition system 100 according to particular embodiments. As may be understood from this figure, the promotional video competition system 100 includes one or more networks 115, a promotional video competition server 120 that may, for example, be adapted to execute a promotional video competition module 300, a database 140, one or more remote computing devices 154 (e.g., a smart phone, a tablet computer, a wearable computing device, a laptop computer, a desktop computer, etc.). In particular embodiments, the one or more computer networks 115 facilitate communication between the promotional video competition server 120, the database 140, and the one or more remote computing devices 154.

The one or more networks 115 may include any of a variety of types of wired or wireless computer networks such as the Internet (or other WAN), a private intranet, a mesh network, a public switch telephone network (PSTN), or any other type of network (e.g., a network that uses Bluetooth (standard or low energy Bluetooth), beacon communication technologies (e.g., iBeacon), and/or near field communications to facilitate communication between computing devices). The communication link between the one or more remote computing devices 154 and the promotional video competition server 120 may be, for example, implemented via a Local Area Network (LAN) or via the Internet (or other WAN).

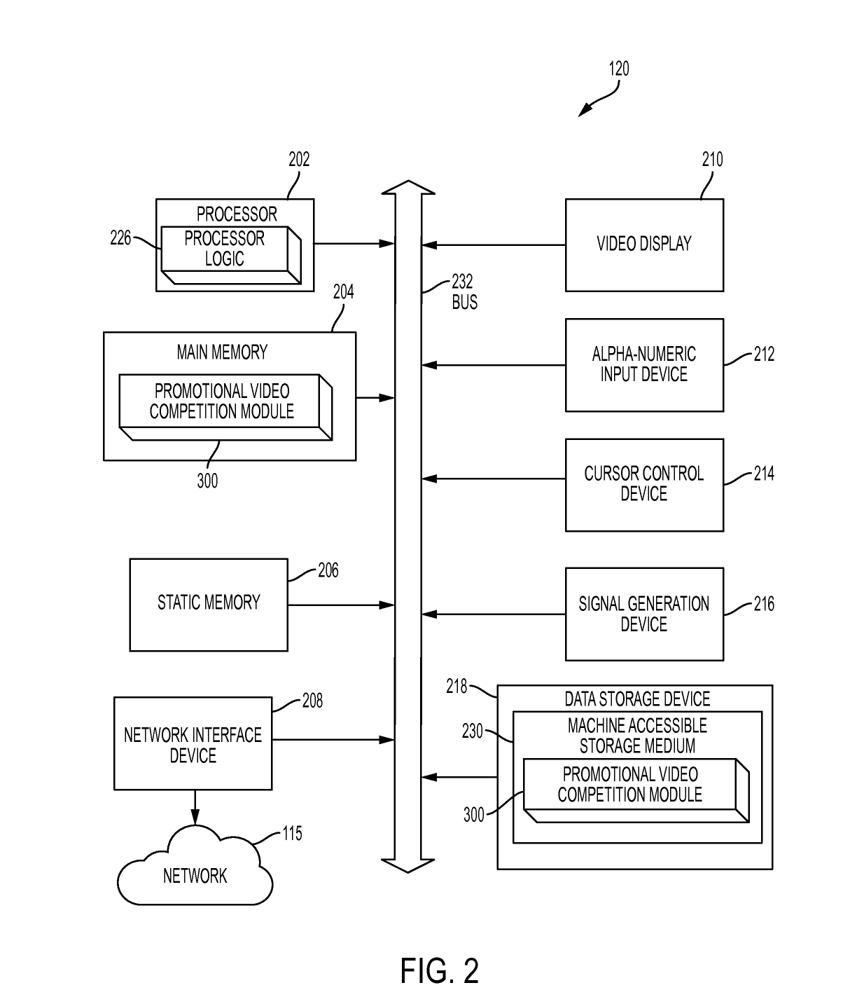

FIG. 2 illustrates an exemplary diagrammatic representation of the architecture for a promotional video competition server 120 that may be used within the promotional video competition system 100. It should be understood that the computer architecture shown in FIG. 2 may also represent the computer architecture for any one of the one or more remote computing devices 154 shown in FIG. 1. In particular embodiments, the promotional video competition server 120 may be suitable for use as a computer within the context of the promotional video competition system 100 that is configured for incentivizing bartenders and other individuals to promote a particular brand of alcohol via a promotional video competition.

In particular embodiments, the promotional video competition server 120 may be connected (e.g., networked) to other computing devices in a LAN, an intranet, an extranet, and/or the Internet as shown in FIG. 1. As noted above, the promotional video competition server 120 may operate in the capacity of a server or a client computing device in a client-server network environment, or as a peer computing device in a peer-to-peer (or distributed) network environment. The promotional video competition server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the single term “computing device” (or other such singular terminology referring to a computing device) shall also be interpreted to include any collection of computing devices that individually or jointly execute a set (or multiple sets) of instructions to perform any one or more of the methodologies discussed herein.

As shown in FIG. 2, an exemplary promotional video competition server 120 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other and other system components via a bus 232.

The processor 202 represents one or more general-purpose or specific processing devices such as a microprocessor, a central processing unit (CPU), or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processor 202 may be configured to execute processing logic 226 for performing various operations and steps discussed herein.

The promotional video competition server 120 may further include a network interface device 208. The promotional video competition server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computer-readable medium) on which is stored one or more sets of instructions (e.g., the promotional video competition module 300) embodying any one or more of the methodologies or functions described herein. The promotional video competition module 300 may also reside, completely or at least partially, within the main memory 204 and/or within the processor 202 during execution thereof by the promotional video competition server 120—the main memory 204 and the processing device 202 also constituting computing device-accessible storage media. The promotional video competition module 300 may further be transmitted or received over a network 115 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Operation of Exemplary System

As noted above, a Promotional Video Competition System 100, according to various embodiments, is adapted to incentivize bartenders and/or other individuals to promote a particular brand of alcohol (or other product) via a promotional video competition. Various aspects of the system's functionality may be executed by certain system modules, including the promotional video competition module 300. The promotional video competition module 300 is discussed in greater detail below.

Promotional Video Competition Module

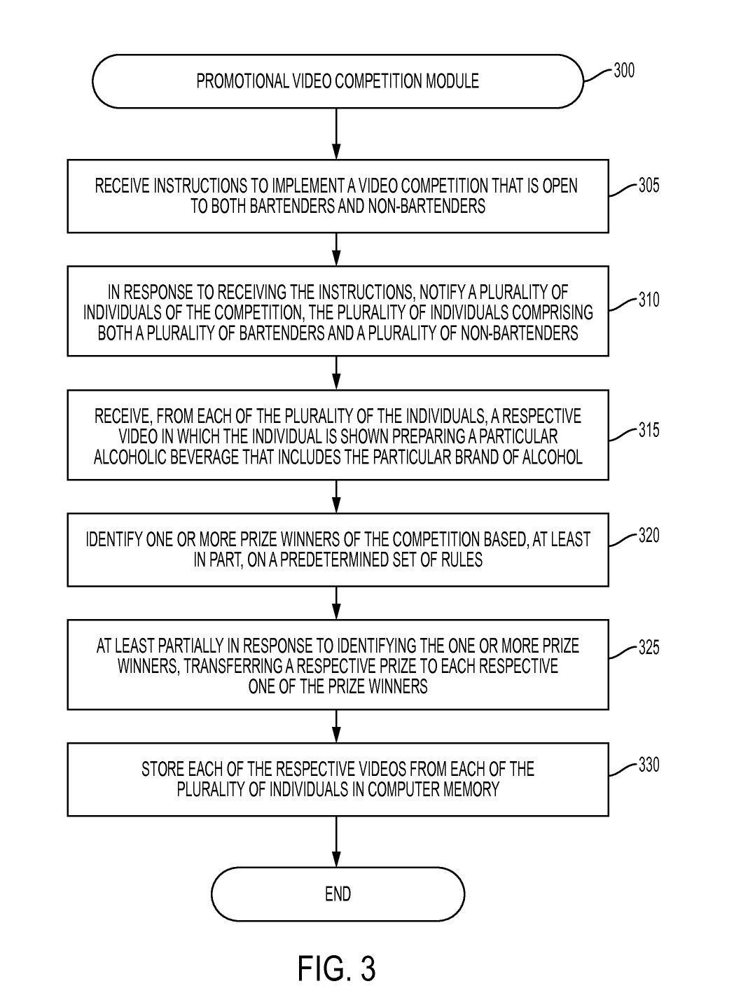

FIG. 3 shows a flow chart of operations performed by an exemplary promotional video competition module 300, which may, for example, run on the promotional video competition server 120, or any suitable computing device (such as a suitable mobile computing device). In particular embodiments, the promotional video competition module 300 facilitates incentivizing an individual to promote one or more products, such as a particular brand of alcohol, via a promotional video competition.

The system begins, in various embodiments, at Step 305 by receiving instructions to implement a video competition that is open to both bartenders and non-bartenders. In various embodiments, the system may receive instructions to implement a video competition from an alcohol producer, alcohol distributor, alcohol sales representative, or any other suitable entity. In particular embodiments, the video competition may include any suitable type of video competition in the context of promoting a particular product or service (e.g., a competition in which a plurality of competing individuals each produce and submit for review (e.g., film, edit, and submit for review) a respective video showing the individual preparing a particular mixed drink with a particular brand of alcohol). In particular embodiments, the computer system and/or one or more human judges evaluates the submitted videos and determines one or more winners of the video based, for example, on the quality and/or the popularity the videos. In various embodiments, the computer system may base the judging on the number of impressions a video receives (e.g., on one or more social media websites) and/or on the number of potential impressions a video may receive (e.g., on one or more social media websites). In some embodiments, the system may base the judging on the number of plays a video receives, the length of time the video was played, whether the video was watched in its entirety, whether the video was watched multiple times by the same individual, the number of times the video was shared, and/or the number of votes the video received. In various embodiments, the system may be adapted to communicate, to an individual who prepared the video (or to other individuals) how a particular score for a particular video was determined (e.g., the system may display a visual or other depiction of the video's total score along with a visual or other indication of each judging criteria that lead to the video's total score).

In particular embodiments, the instructions received at Step 305 may include that the video competition should only be open to individuals (e.g., bartenders and/or other individuals) that live or work in a particular geographic region (e.g., the United States). In various embodiments, the instructions may, alternatively or additionally, limit entry into the competition based at least in part on the potential entrant's occupation (e.g., the competition may only be open to doctors, lawyers, accountants, bartenders, etc., or to non-lawyers, non-bartenders, etc.). In some embodiments, the instructions may include that the video competition is only open to individuals with a user account registered with the system.

In particular embodiments, the instructions to implement the video competition may include a predetermined set of rules that must be followed by entrants when producing their respective videos. In various embodiments, the predetermined set of rules may include who may enter the video competition. For example, the predetermined set of rules may include that any individual over the age of 21 may enter the video competition. In some embodiments, the predetermined set of rules may specify a particular alcoholic mixed drink that should be prepared in each video submitted for the video competition. For example, the predetermined set of rules may specify that any video showing an individual preparing any mixed drink that includes a particular type of alcohol (e.g., a particular type of bourbon or gin) may be submitted into the video competition. In other embodiments, the predetermined set of rules may specify that, in order to be entered into the competition, a video must show an individual preparing a particular type of mixed drink that includes a specific brand of alcohol. For example, the predetermined set of rules may specify that each video must show an individual, who is in a bar when the video is filmed, preparing an Old Fashioned cocktail with Jim Beam whiskey.

In particular embodiments, the predetermined set of rules may include a deadline as to when the video must be submitted for the video competition. For example, the video competition may include a daily competition (e.g., the deadline for submitting videos for entry into the competition may be within about 24-36 hours from the start of the competition) or a weekly competition (e.g., the deadline for submitting videos for entry into the competition may be within about 7 to 8 days from the start of the competition, etc.). For example, the predetermined set of rules may specify that the video must be submitted before the last day of a particular month. In some embodiments, the predetermined set of rules may specify a minimum and/or a maximum length of time for the video that is submitted. For example, the predetermined set of rules may specify that the video submitted must be between 15 seconds and 45 seconds long. In various embodiments, the predetermined set of rules may specify a type of location (and/or a specific location) where the video must be filmed in order to qualify for entry into the video competition. For example, the predetermined set of rules may specify that the video must be filmed in a bar.

In various embodiments, the predetermined set of rules may specify how the video must be prepared for entry into the video competition. For example, the predetermined set of rules may specify that the video must be created using a particular video production application, such as the video production application discussed below. In alternate embodiments, the predetermined set of rules may include one or more rules that will be used to select one or more winners of the video competition. For example, the rules may specify that one or more winners will be selected based, at least in part, on one or more objective measures of the popularity of the video (e.g., based, at least in part, on the number of “likes” that the video receives on one or more social media accounts and/or the number of times that the video was shared in one or more social media environments). In some embodiments, the rules for selecting one or more winners may include one or more subjective measurements of the video's quality (e.g., the subjective originality of the mixed drink created in the video).

At Step 310, at least partially in response to receiving the instructions, the system notifies a plurality of individuals of the competition, where the plurality of individuals comprise both a plurality of bartenders and a plurality of non-bartenders. In various embodiments, the system may notify the plurality of individuals via any traditional advertising channel (e.g., email, billboard advertising, radio, television, online advertising, etc.). For example, the system may send a notification of the competition to a plurality of individuals (e.g., only individuals who qualify to compete in the competition, or another set of individuals) that have downloaded a particular app onto their mobile computing device. In such embodiments, the system may notify the plurality of individuals by sending a notification to each respective individual's mobile device. In particular embodiments, the system may send a notification of the competition to a plurality of individuals that have set up a user account with the system. In some embodiments, the system may notify the plurality of individuals that have indicated in their user account that they wish to be notified of current video competitions.

In various embodiments, the system notifies the plurality of individuals by any suitable means (e.g., displaying an image on each individual's respective mobile computing device, through an audio speaker of the individual's mobile computing device, via an electronic communication such as an email or text message). In particular embodiments, the system may notify the plurality of individuals of a single video competition that the individual may be interested in based on the user's preferences. In other embodiments, the system may notify the plurality of individuals of all video competitions currently in progress.

In particular embodiments, the system may notify the plurality of individuals of the competition after (e.g., in response to, which may also include at least partially in response to) receiving instructions to implement a video competition. For example, the system may notify the plurality of individuals of the video competition in response to the system receives instructions to implement a video competition from an alcohol producer.

Continuing to Step 315, the system receives, from each of the plurality of individuals, a respective video in which the individual is shown preparing a particular mixed drink that includes the particular brand of alcohol. In various embodiments, each of the plurality of individuals has installed a particular video production application onto the individual's mobile computing device (or other computing device) that: (1) facilitates the use of a camera associated with the individual's mobile computing device (e.g., a front or rear facing camera built into the mobile computing device) to record footage to be used within the video; and (2) provides editing and other video production capabilities to allow the user edit and finalize the production of their video on their portable computing device (or other computing device). In some embodiments, the video production application may facilitate having the individual record video footage in sections, and then automatically combine the different sections of footage into a single video. For example, the video production application may allow the individual to record an introduction section and a section showing the individual making a particular alcoholic beverage, and then combine these two sections (e.g., with other audio, video, or graphics elements) to form a single, cohesive video.

According to various embodiments, the video production application may receive additional information such as text from the individual for use in the video. In particular embodiments, the text may include the name of the mixed drink that the individual is making in the video and the various ingredients used in making the mixed drink. In some embodiments, the text may include a location (e.g., a particular bar or other location) where the alcoholic beverage was made.

In particular embodiments, the video production application may receive an indication of a type of font to use in displaying one or more portions of the additional information received from the individual. In some embodiments, the system may limit the number of fonts from which the individual may select a number that is equal to or less than a predetermined maximum number of fonts. For example, the number of different fonts available may be limited to six different fonts. In particular embodiments, the system may receive an indication of the color for the font from the individual. In other embodiments, the system may automatically select the font and/or font color for the individual.

In various embodiments, the video production application may receive an indication of a music theme for background music from the individual (which may be used to determine one or more songs to be used as background music within the video). In some embodiments, one or more such music themes may be representative of a particular music genre. For example, the music themes may include music for the genres of rock, classical, R&B, pop, rap, alternative, blues, jazz, etc. In particular embodiments, the system may limit the number of different music themes available for selection. For example, the number of available music themes may be limited to any of eight different music themes.

In particular embodiments, the system may automatically select a music theme for the individual. In some embodiments, the system may automatically select the music theme for the individual at least partially based on the font selected either automatically by the system or by the individual. For example, the system may select an “acoustic rock” music theme in response to the user selecting a modern font (e.g., Calibri) for use in displaying text within the video.

In various embodiments, the video production application may auto-format a textual representation of the additional information received from the individual, and insert the resulting text into the video recording received from the individual. In particular embodiments, the system may also automatically speed up one or more sections of the video recording received from the individual (e.g., from a camera associated with the individual's mobile computing device). For example, the system may automatically speed up video footage showing the individual mixing a particular mixed drink.

In some embodiments, the video production application may receive an indication from the individual to slow down a particular portion of the video footage during playback. For example, the individual may select a “video slow down” icon on a user interface associated with the individual's mobile computing device and drag the icon to a particular position on a graphical representation of the video footage to slow down the portion of the video footage that corresponds to the particular position. In other embodiments, the video production application may automatically slow down a particular portion of the video footage during playback without input from the individual.

In particular embodiments, the video production application may receive one or more voiceovers from the individual for playback while one or more particular sections of the video footage is shown in the final version of the recording. This may, for example, allow the individual to record video of a particular mixed drink preparation technique, and then add an audio description of the technique at a later time.

In various embodiments, in addition to receiving a video from each of a plurality of individuals, the system receives account settings preferences from each of the individuals. In some embodiments, the account setting preferences may include one or more types of competitions that the individual would like to be notified about for current video competitions. In particular embodiments, the account setting preferences include the individual's preferences for receiving prizes if the individual is selected as a prize winner, as will be discussed further below. In some embodiments, the account setting preferences include the individual's preferences for preset fonts and/or music themes to be used in the individual's future video productions made using the application.

In various embodiments, at least partially in response to receiving relevant video footage, one or more font selections, one or more music selections, one or more voiceovers and/or other suitable data and/or video elements from the individual, the video production application automatically generates a final version of the video for use in the video competition. In particular embodiments, the system may save the video to suitable computer memory. In some embodiments, the system may automatically submit the video into the video competition in response to the final video being generated. In other embodiments, the system may submit the video into the video competition in response to receiving an indication from the individual that the video may be submitted to the video competition.

At Step 320, the system identifies one or more prize winners of the competition based, at least in part, on a predetermined set of rules (e.g., judging criteria) for the competition. In various embodiments, the one or more prize winners may be all entrants into the video competition. In some embodiments, the one or more prize winners may include at least a predetermined percentage of all of the entrants for the video competition (e.g., at least 50%, 75%, 99% of the entrants).

In various embodiments, the system identifies one or more of the prize winners based on one or more objective and/or subjective factors specified in a set of rules associated with the competition. In particular embodiments, the system gathers and aggregates information from a plurality of social media sources such as Facebook, YouTube, Twitter, and/or Vimeo. In particular embodiments, the system identifies one or more of the prize winners based, at least in part, on: (1) the popularity of the video on one or more social medial web sites (e.g., as measured by the number of “likes” that the video receives on a social media web site, or the number of times that the video is shared between users of social media web sites; (2) the number of votes that the video receives in a voting process, which may, for example, be conducted on-line and which may be open to the public; (3) the number of times that a particular product (e.g., a particular brand of alcohol) is mentioned within video; (4) random prizewinner selection; and/or (5) any other factor. In some embodiments, the system may identify the one or more prize winners based on the uniqueness of the video submitted by a particular individual. For example, where an individual makes a drink while performing a dirt bike stunt, the system may determine that the individual's video is the most unique and identify this individual as a prize winner. The system may, in some embodiments, determine the winner using analytic capture and aggregation of distributed metrics across a large, diverse ecosystem of social sites and mobile experience. As noted above, in various embodiments, the system may score the contest based, at least in part, on social performance on social media.

In various embodiments, the one or more votes (e.g., “likes”) received may be weighted differently in determining the outcome of the competition according to one or more factors. In particular embodiments, a video may be given extra credit in the competition for each positive vote (e.g., a “like” or other positive vote) that the video receives from an individual who has recently been in the presence of (e.g., is currently in the presence of (e.g., at the same location as, or within a predetermined radius of) or who was in the presence of within a recent predetermined period of time) the person who made the video and/or the person who is shown preparing the mixed drink in the video. In addition, a video may be given extra credit in the competition for each positive vote (e.g., a “like” or other positive vote) that the video receives from an individual who has recently been in the location where the video was made (e.g., is currently in the location or who was in the location within a recent predetermined period of time). Such votes may indicate that the voting individual has received a “word of mouth” recommendation of the mixed drink and/or a particular brand of alcohol within the mixed drink, which various embodiments of the system are intended to encourage.

In some embodiments, the system may gather data about the individuals viewing the particular video and use the gathered data to score the competition. The one or more winners may be determined based, at least in part, on the viral success of their particular video. For example, the system may measure the viral success from the perspective of a contest delivery network. In particular embodiments, the success score of a submission may be measured from a variety of inputs from the contest delivery network, such as the byte size of the media item, the cumulative bytes delivered across the network for that media item, the quantity of unique client requests, the timing patterns of those requests, the type and variety of channel sources (e.g., Facebook, Twitter, etc.), the geographic distribution of requests, etc. In some embodiments, the system may collect internal application data to be input into the scoring algorithm, such as likes, shares, impressions, views, loops, lists, dwell time, completion, etc. The system may also collect external data to be input into the scoring algorithm, such as Facebook likes and shares of a submission URL, Twitter firehose data, etc.

In particular embodiments, the system may determine the current respective location of the individual who prepared the video (and/or who is shown preparing a mixed drink within the video) and/or the location of the individual who is voting on the video using a respective computing device associated with each of the respective individuals noted above (e.g., a smartphone, a smart watch, a tablet computer, etc.). In particular embodiments, for example, the location of each respective individual may be determined using a GPS unit associated with the individual's smartphone (e.g., when a user “checks in” to a particular location), suitable triangulation techniques, and/or any other suitable method for determining an individual's location.

Referring to Step 325, at least partially in response to identifying the one or more prize winners, the system transfers a respective prize to each respective one of the prize winners. In various embodiments, the system may electronically transfer a respective prize to each of the respective one of the prize winners. For example, the system may transfer a prize to a prize winner via PayPal, Google Wallet, Venmo, direct deposit to a bank, etc. according to the prize winner's account settings. In some embodiments, the system may transfer the respective prizes to the prize winners via the postal system (e.g., via USPS, UPS, FedEx, etc.). In particular embodiments, the system may notify the prize winners of the transfer of the respective prizes via an electronic communication such as email, a pop-up message, text message or any other suitable method of providing notification to the prize winners.

In various embodiments, the respective prize may be any suitable prize, such as: (1) a cash prize; (2) a gift card; (3) a physical object, such as a tablet computer; or (4) points that may be exchanged for goods or services.

At Step 330, the system stores each of the respective videos from each of the plurality of individuals in computer memory. In particular embodiments, the system may store the respective videos in a cloud storage server or other server or other suitable remote storage location for later retrieval. In various embodiments, the system may store the videos substantially automatically in response to receiving the videos. In some embodiments, the system may store the videos in response to receiving manual input from the user requesting that the system store the videos. In particular embodiments, the system may store the videos for a specified period of time. For instance, the system may store the videos for a day, a month, a year, etc. In some embodiments, the system may store the videos on any suitable server, database, and/or device. In particular embodiments, the system may store the videos on the promotional video competition server 120. In alternate embodiments, the system may store the videos in association with an account associated with the user. In some embodiments, the system may store the videos with a timestamp of when the videos were received.

In various embodiments, the system may store the videos for use as an electronic cocktail menu. In some embodiments, the cocktail menu may be part of the functionality offered by a mobile application that allows the user to enter the video competition. In various embodiments, the cocktail menu may be electronically searchable (e.g., keyword searchable) for one or more different drinks, bartenders, etc. In particular embodiments, the electronic cocktail menu may include one or more videos in which an individual is shown preparing a particular alcoholic beverage (e.g., mixed drink) that includes a particular brand of alcohol. In various embodiments, the individual shown preparing the particular mixed drink may be a bartender at a particular bar (e.g., the bartender who is currently on duty at the bar) that is using the cocktail menu to advertise the particular bar's cocktails. For example, the bartender in the video may be the bartender that would prepare the cocktail featured in the video if the cocktail were ordered at the bar at the time that the video is viewed. In some embodiments, the electronic cocktail menu may include multiple videos in which an individual is shown preparing a particular respective mixed drink. For example, one video included within the electronic cocktail menu may show an Old Fashioned prepared with Larceny® bourbon and another video may show a Mint Julep prepared with Larceny® bourbon, or another type of bourbon.

In a particular embodiment, the system is configured for: (1) receiving multiple respective videos, each of which shows a different respective bartender at a particular restaurant or bar preparing a particular mixed drink (or other beverage); (2) after receiving the multiple respective videos, determining which of the respective bartenders would be preparing the particular mixed drink if a customer ordered the mixed drink at, or around, the current time; and (3) in response to determining that a particular one of the respective bartenders would be preparing the particular mixed drink if a customer ordered the mixed drink at, or around, the current time, displaying, as part of a cocktail menu, the respective video showing the determined particular bartender preparing the particular mixed drink. This may, for example, assure that the system's cocktail menu is currently updated to show the actual bartender who will be preparing the particular mixed drink if the particular mixed drink is ordered from the cocktail menu.

The system may follow this same process for multiple drinks on the cocktail menu so that, for example, the menu may include videos that show different currently working bartenders preparing different mixed drinks. If different bartenders are assigned to serve different customers (e.g., different tables in the restaurant or bar), the system may also be configured to determine which of a plurality of currently working bartenders would prepare a particular mixed drink for a particular customer (e.g., based, at least in part, on where the particular customer is sitting), and then update the cocktail menu to include a video of that determined currently working bartender preparing that particular mixed drink.

In various embodiments, the electronic cocktail menu may be used to show a bartender or other individual how the alcoholic beverage is prepared. In particular embodiments, the electronic cocktail menu may include the ingredients used to make each beverage and instructions for preparing the alcoholic beverage. In some embodiments, the electronic cocktail menu may be provided to patrons of a restaurant and/or bar on a remote computing device in order to enable the patron to better understand and/or order a beverage. For example, a bar may have an iPad at each table that has the electronic cocktail menu stored in memory so that the patron may understand the cocktail menu and place an order. In alternate embodiments, the electronic cocktail menu may be used by a restaurant and/or bar in instructing servers and staff of particular drink specials or specialty cocktails.

According to various embodiments, the system may: (1) receive a first video showing a bartender preparing a first particular mixed drink; (2) receive a second video showing a bartender preparing a second particular mixed drink; (3) receive a third video showing a bartender preparing a third particular mixed drink; and (4) assemble the first, second, and third videos into an electronic menu that can be played on a portable electronic device and that can be used by a customer to selectively view the first, second, and third videos. In some embodiments, the system may store the videos in memory to facilitate playback of the first, second, and third videos to a bartender who will be preparing the first, second, and third alcoholic beverages for customers who order drinks using the electronic cocktail menu.

Exemplary User Experience

Creating Final Video for Video Competition

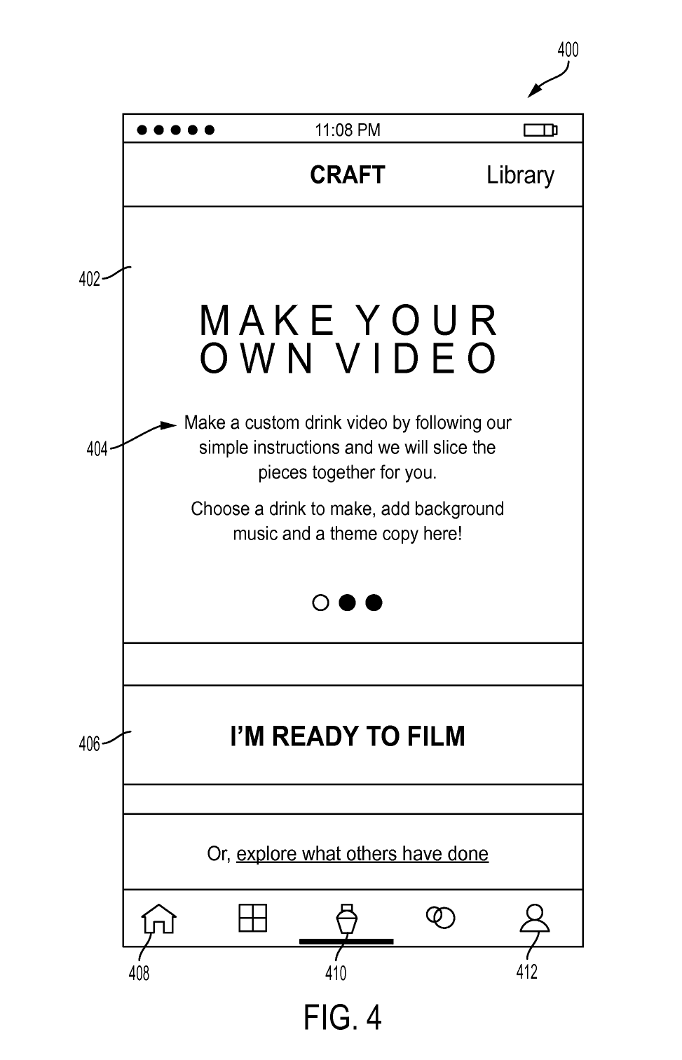

FIG. 4 depicts a user interface 400 that the system may display when a user begins using a suitable video production application, such as those described above. The user may access the video production application from the user's mobile computing device (e.g., the user's smartphone). As may be understood from FIG. 4, the system begins by showing an application description page 402 to the user. The application description page 402 contains information 404 regarding the video production application. On the application description page 402, the user is given the option to begin using the video production application by selecting the “I'm Ready to Film” button 406. The user may also navigate through the video production application by, for example, selecting a home button 408, a beverage button 410, or a profile button 412.

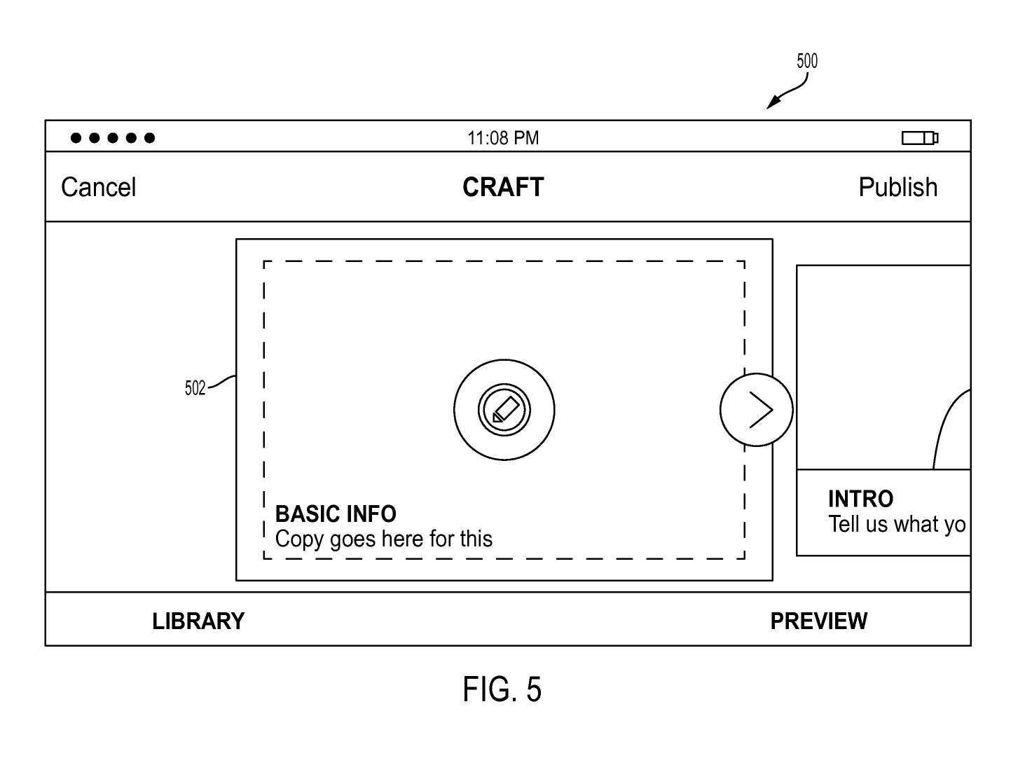

As shown in FIG. 5, in response to selecting the “I'm Ready to Film” button 406 from FIG. 4, the user will be directed to a navigation page 500. On the navigation page 500, the user is presented with an option for entering basic information by selecting a basic info button 502.

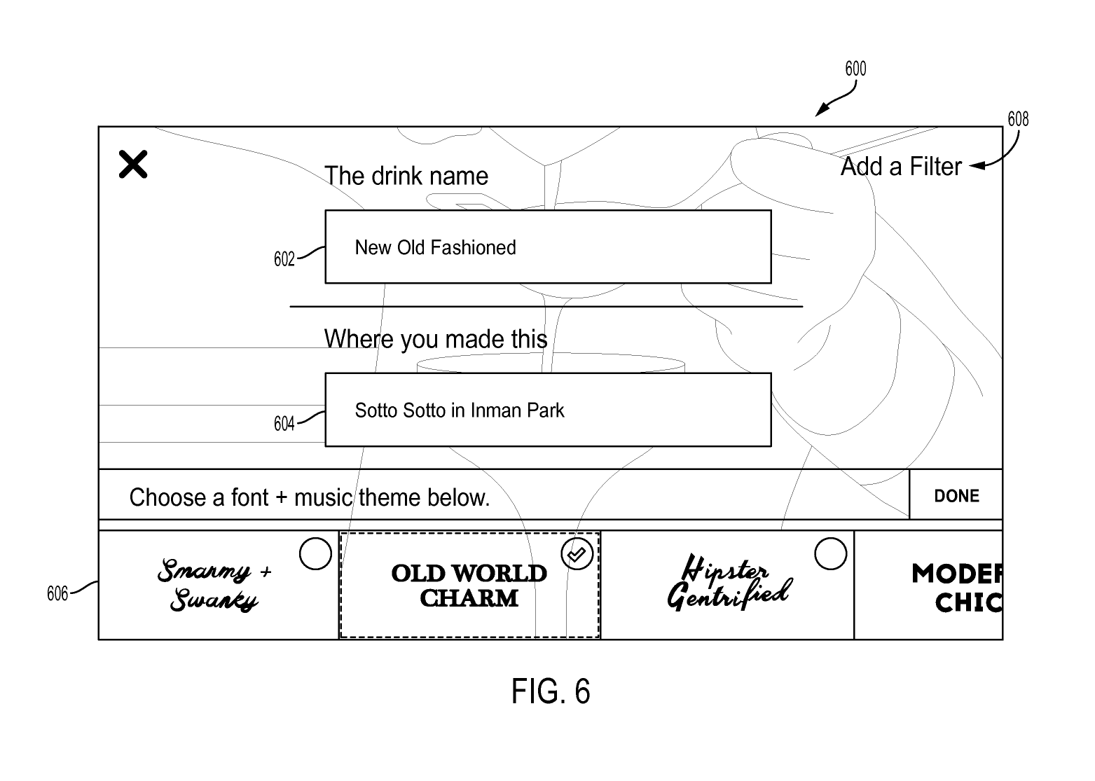

In response to selecting the basic info button 502 of FIG. 5, the user is directed to the basic information input page 600 of FIG. 6. On the basic information input page 600, the user may enter the name of a drink the user will be making into the drink name field 602. The user may also enter where the drink will be made into the “where you made this” field 604. The user may then customize the font for the drink name and the location where the drink was made by selecting a font such as the old world charm font 606. In selecting the font, the system may automatically select a music theme that corresponds to the font for use in the video. In further customizing the information input into the video production application, the user may select the add a filter button 608 in order to add filters such as black and white, sepia, grayscale, etc. to the video.

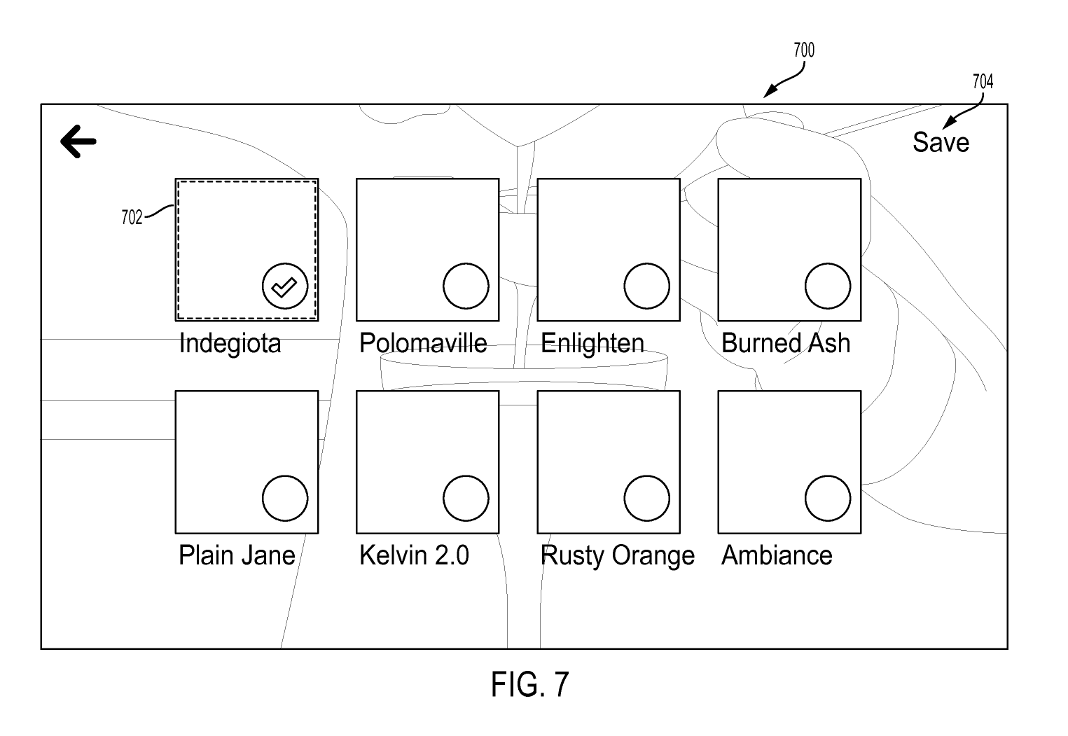

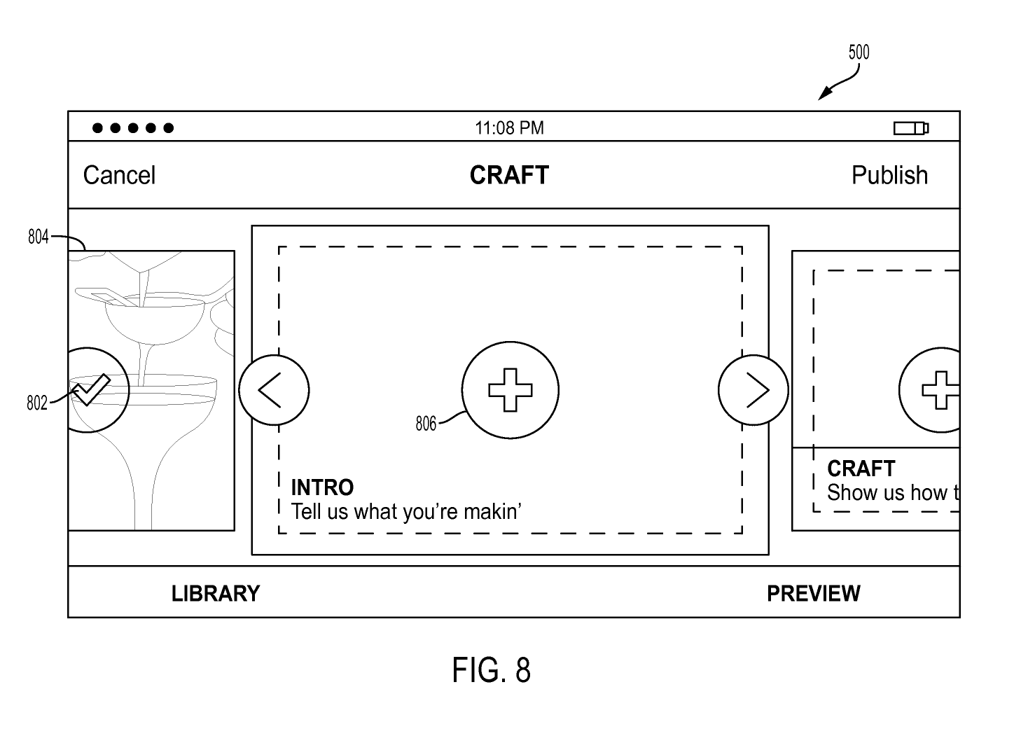

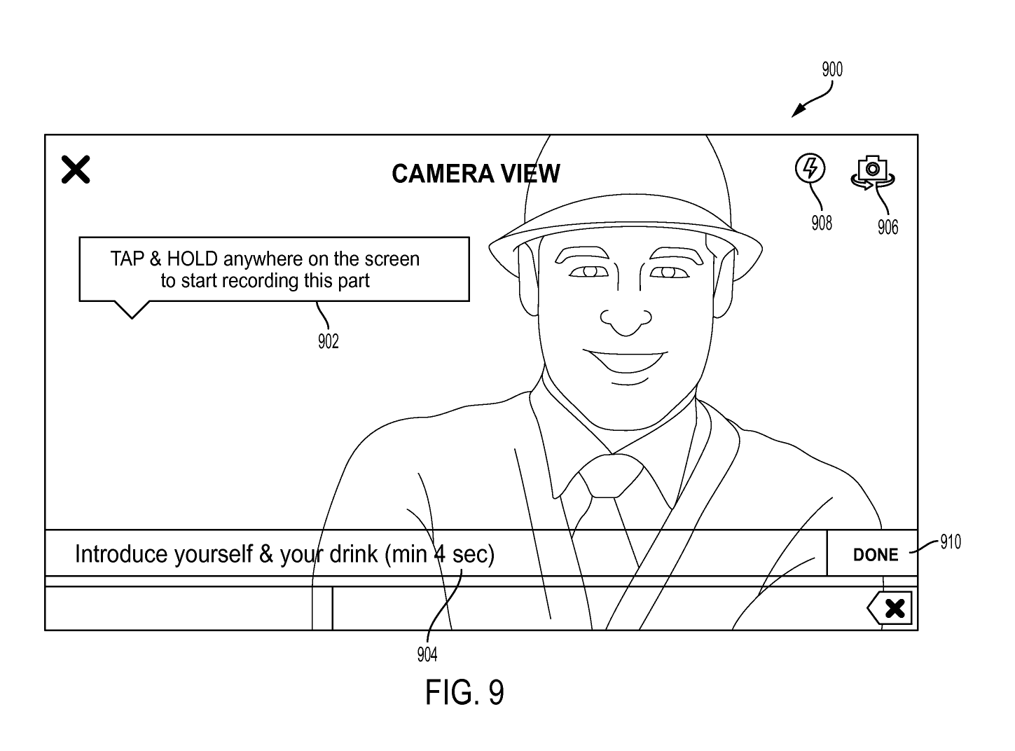

Selecting the add a filter button 608 of FIG. 6 directs the user to select a filter, as shown in the filter page 700 of FIG. 7. In various embodiments, the user may be presented with preselected filters, such as Indegiota 702, or the user may be able to manually adjust the coloring of the video. In response to selecting a particular filter, the user may select the save button 704 to return to the navigation page 500, as shown in FIGS. 5 and 8.

Referring to FIG. 8, in response to entering information into the basic information input page 600 of FIG. 6, the navigation page 500 will display a check mark 802 on the slide 804 representing the basic information input page 600. This check mark 802 indicates that the user has completed the basic information section. From the navigation page 500 shown in FIG. 8, the user may select the intro input button 806 to record introduction video footage for use in the final video.

Selecting the intro input button 806 of FIG. 8 directs the user to the introduction page 900, which facilitates filming footage of the user introducing themselves and their drink. For new users, a pop-up 902 may be displayed with instructions on how to begin recording the introduction. For example, the pop-up may direct the user to tap and hold anywhere on the screen to start recording this part of the video. The introduction page 900 may also display text explaining that the user is required to film a certain length of footage for the introduction. The introduction page 900 includes a switch camera button 906 for switching between the mobile computing device's cameras and a flash button 908 for turning on and off the flash. Upon completing the recording for this part, the user may select the done button 910 to return to the navigation page 500.

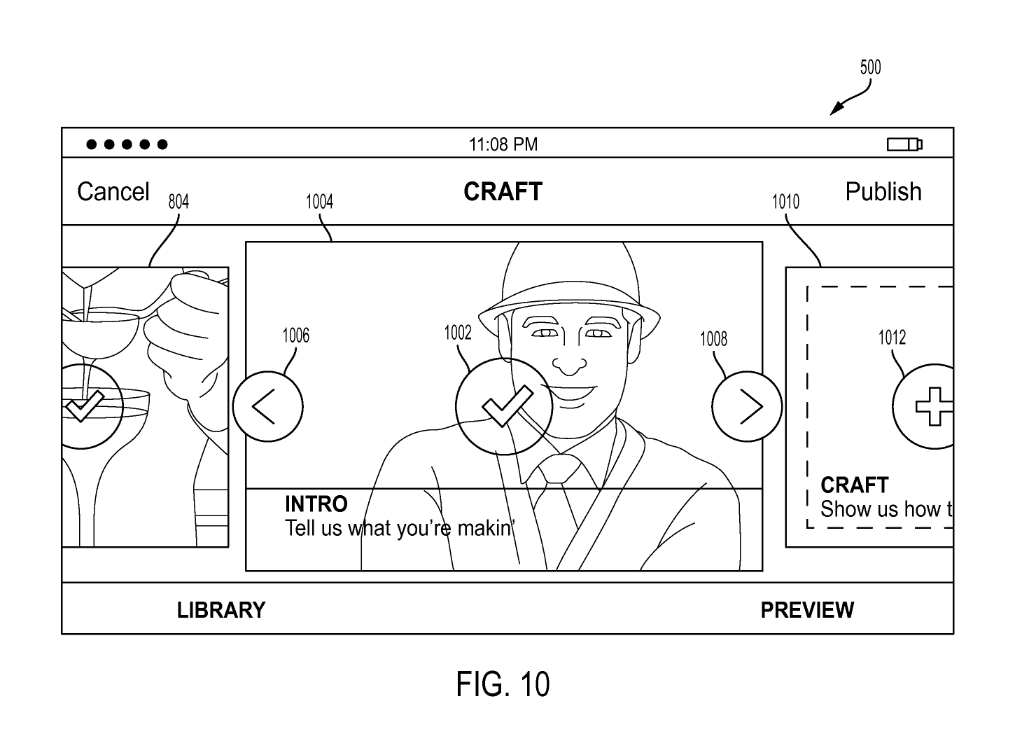

Similar to the navigation page 500 of FIG. 8, the navigation page 500 shown in FIG. 10 depicts a second check mark 1002 on the slide 1004 representing the introduction page 900. This second check mark 1002 indicates that the user has completed the introduction section. From the navigation page 500, the user may select the left arrow 1006 to display the basic information input page slide 804, or the right arrow 1008 to display the craft beverage slide 1010. Thus, on the navigation page 500, the user may scroll through the various sections of the video production application to input information and to make changes to already completed sections. To continue to the craft beverage page, the user may select the craft beverage button 1012.

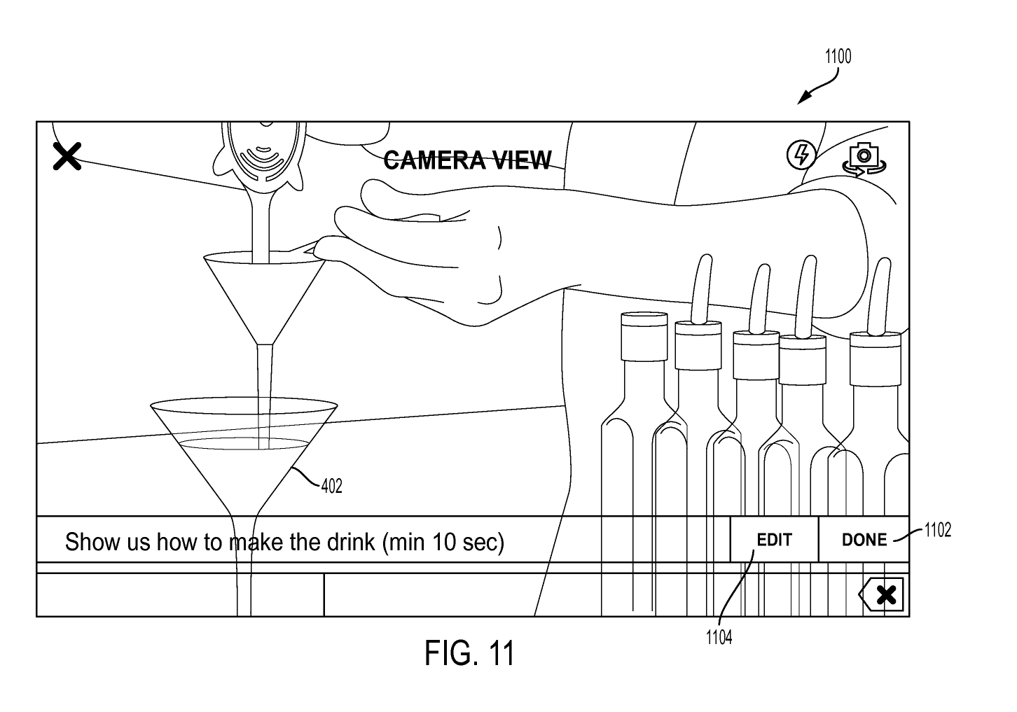

Turning to FIG. 11, in response to selecting the craft beverage button 1012 from FIG. 10, the user is directed to the craft beverage page 1100. While on the craft beverage page 1100, a user may record the user crafting a particular mixed drink. In various embodiments, the user may place the mobile device on a stand in order to facilitate filming while using both hands to make the drink. In some embodiments, the user may have another individual hold the mobile device to film the user making the drink. In particular embodiments, the user may attach the mobile device to the wearer's body to film the user making the drink from the user's perspective. Similar to the introduction section, the craft beverage page 1100 may require that the user film for a minimum amount of time. Once the user has finished filming the crafting of the particular alcoholic beverage, the user may select the done button 1102. However, if the user wants to edit particular portions of the recorded video, the user may select the edit button 1104.

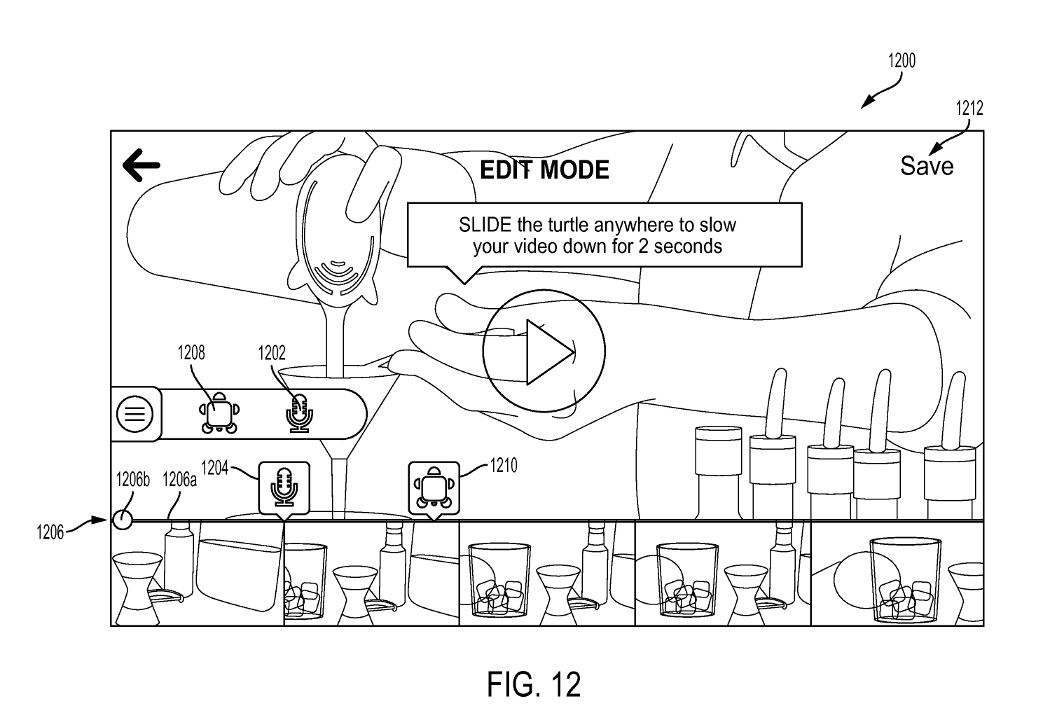

Continuing to FIG. 12, by selecting the edit button 1104, as discussed with reference to FIG. 11, the user is directed to the edit mode page 1200. While in edit mode, the user may select the microphone button 1202 to insert voiceover audio clips into the recorded video at any desired point within the recorded video by selecting a particular point 1204 along the video bar 1206 (which is a representation of the video, in which the position of the currently displayed frame of the video is represented by a circle icon relative to a line that corresponds to the full set of frames in the video). In various embodiments, the video bar 1206 (e.g., a graphical icon for enabling a user to index into desired positions of a video stream), as understood by those skilled in the art, allows a user to move forwards and backwards through a video and select particular frames within the video. The video bar 1206 includes a bar 1206a representing the total time of the video and a video position icon 1206b representing a particular position in the video. The user may also select a video slow down button 1208 (which may be, for example, in the shape of a turtle, yield sign, or any other symbol) to slow down sections of the recorded video that have been automatically sped up by the video production application. Similar to adding voiceover audio to a particular point 1204, the video slow down icon 1210 may be positioned (e.g., by the user) along the video bar 1206 at any point desired by the user. The system will then, in the final version of the video, slow down playback of the frames that correspond to the selected location on the playback bar. The video slow down button 1208 may be useful in adding emphasis to particular parts of the video or to highlight the skills of the user preparing the beverage in the video. In response to all desired edits have been made, the user may select the save button 1212 to return to the navigation page 500.

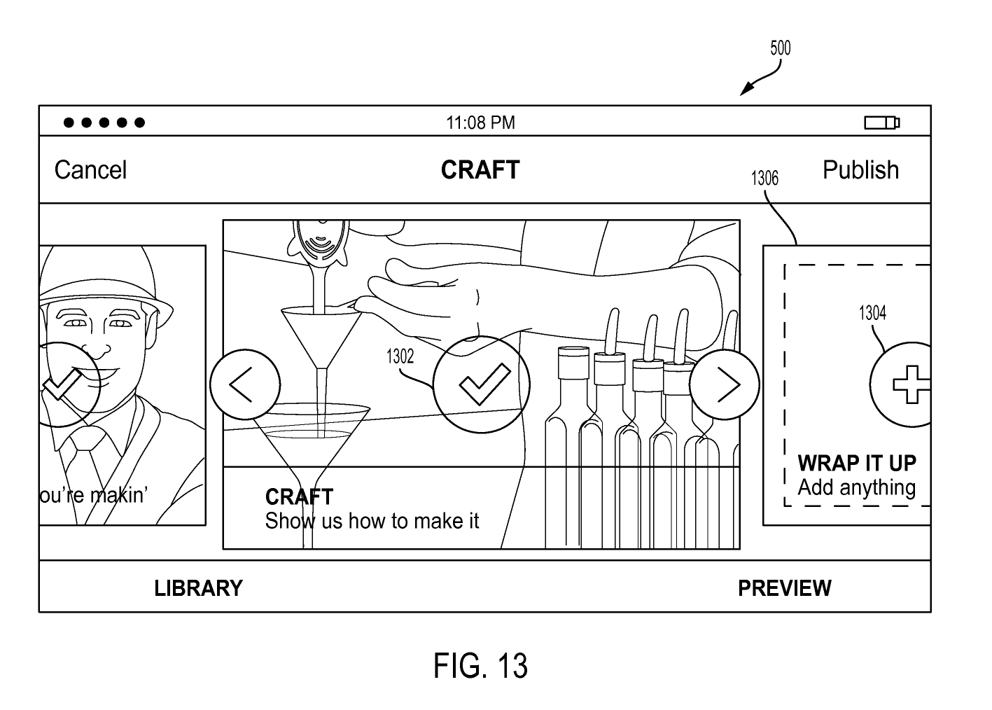

The navigation page 500, as shown in FIG. 13, depicts the user's completion of the craft beverage section with a third check mark 1302. By scrolling through the navigation page 500, the user is able add additional information by selecting the additional information input button 1304 on the additional information page slide 1306.

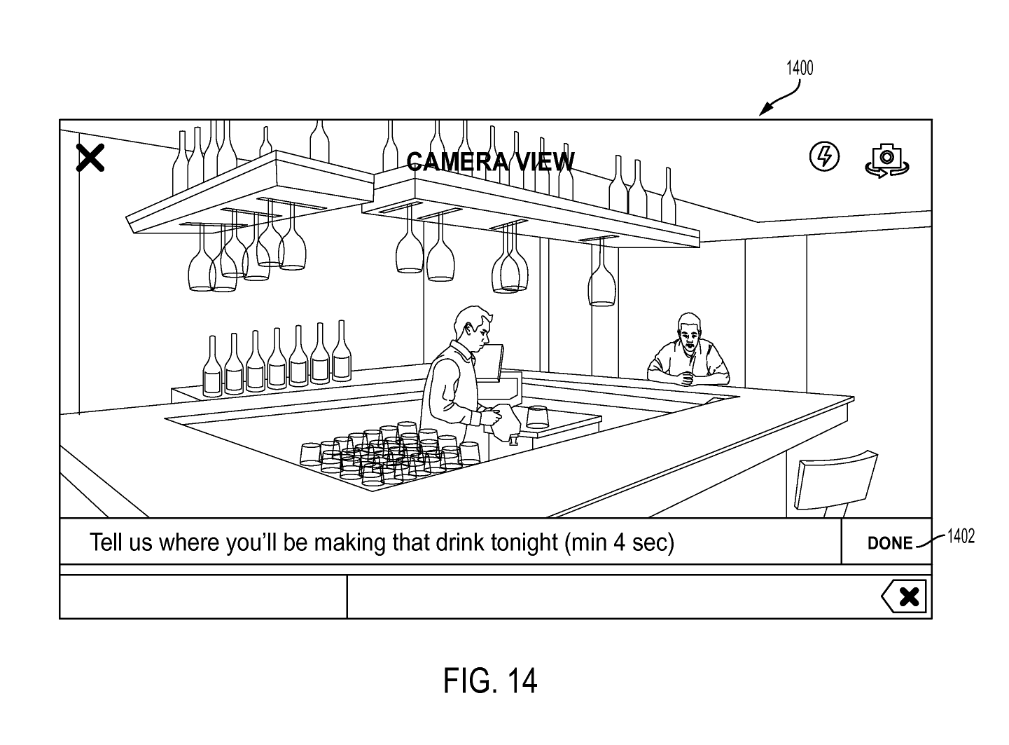

Referring to FIG. 14, in response to selecting the additional information input button 1304 from FIG. 13, the user is directed to the additional information input page 1400. In the additional information input page 1400, the user may add additional information such as where the drink was made, a photograph of where the drink was made, and/or a video showing the location of where the drink was made. For bartenders, the additional information may include where the bartender will be bartending that day. Once completed with adding additional information, the user may select the done button 1402 to return to the navigation page 500.

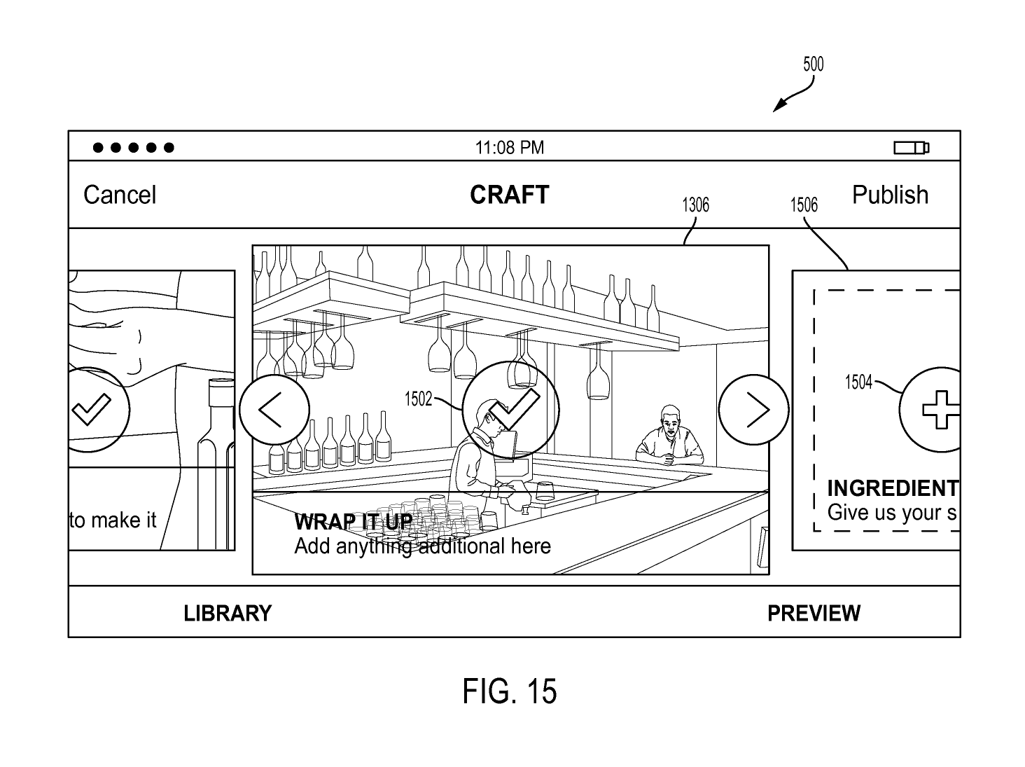

Returning to the navigation page 500 in FIG. 15, the additional information page slide 1306 now depicts a fourth check mark 1502 indicating that this section has been completed. To continue using the video production application, the user may select the ingredients button 1504 on the ingredients page slide 1506 to enter the ingredients used to make the particular alcoholic beverage.

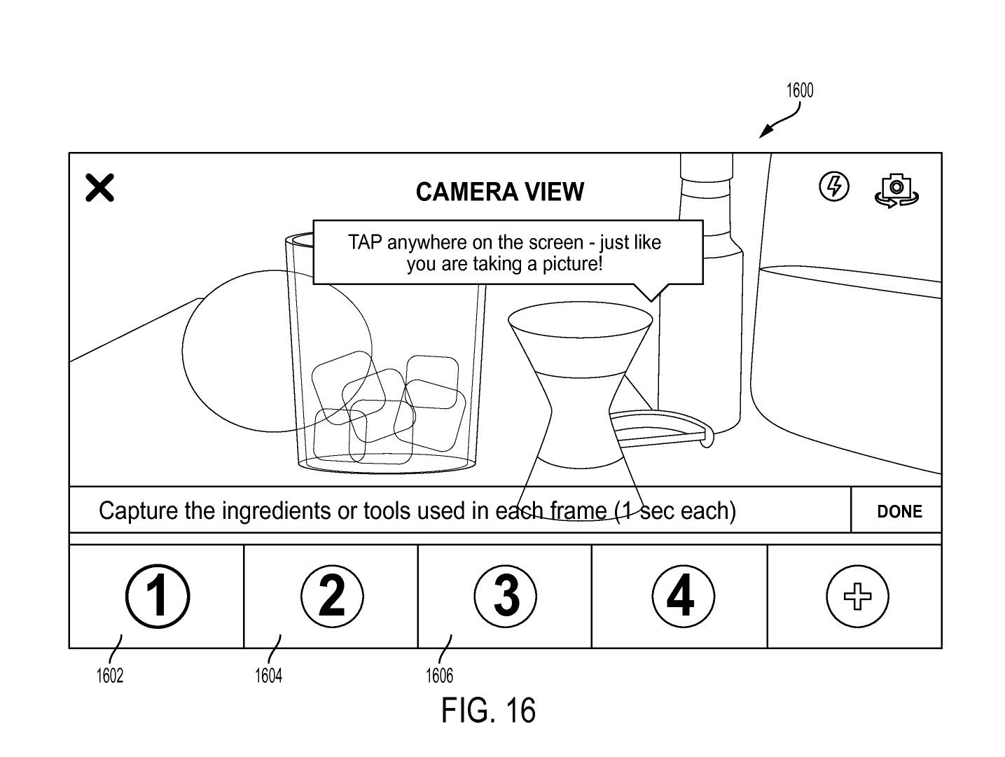

Turning to FIG. 16, in response to selecting the ingredients button 1504, the user is directed to the ingredients page 1600 where the user may enter information regarding one or more ingredients used to make the particular mixed drink. The information may include one or more pictures of each of the ingredients. The user may select the first frame and then tap anywhere on the screen to capture a screen clip 1602, 1604, 1606 that includes a portion of the full image shown on the screen, where the portion of the full image is less than the full image and includes the portion of the screen that was selected by the user. For example, the portion of the full image may be a square, circular, or any other shaped image, of a predetermined size, that has its center at the screen location selected by the user. As a particular example, the user may select the first frame 1602, and then tap on the picture of the liquor bottle. In response to the user taping on the picture of the liquor bottle, the system may capture a small rectangular screen clip that includes the liquor bottle. The user may capture as many clips 1602, 1604, 1606 as is desired. In addition, the user may rearrange the clips 1602, 1604, 1606 by dragging and dropping the frames into the desired order.

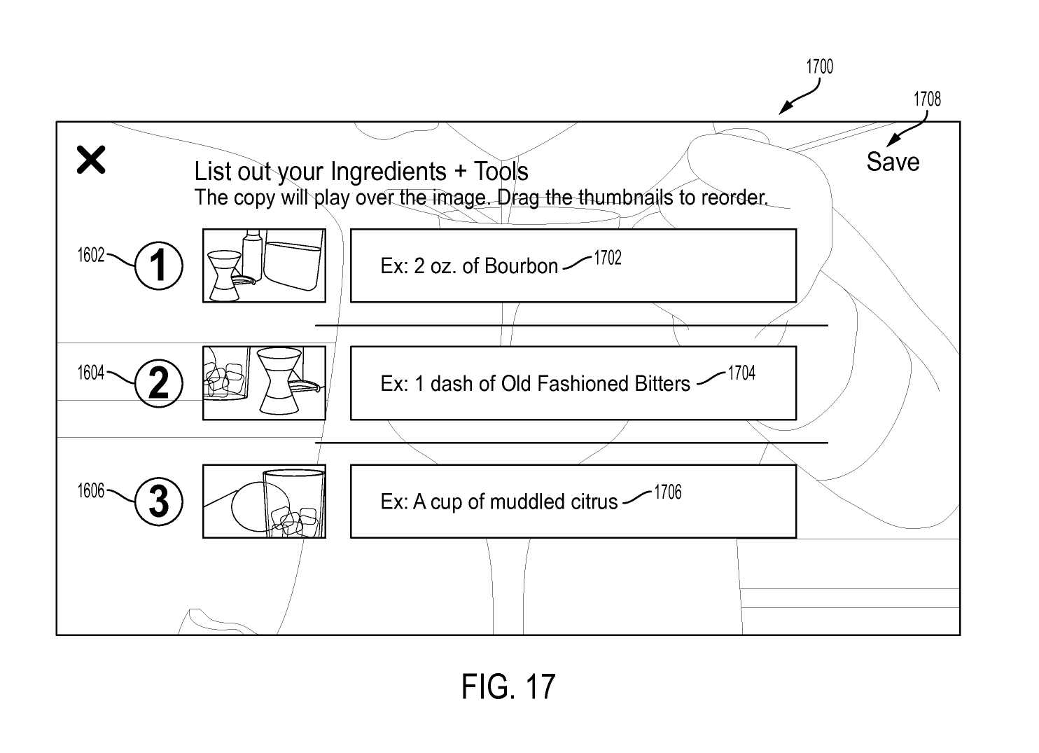

In addition to capturing a screen clip of the ingredient, the system may direct the user to an ingredient list page 1700, as shown in FIG. 17. On this page, the system may display each of the screen clips 1602, 1604, 1606 obtained as described above. The system may display a respective word field 1702, 1704, 1706 beside each ingredient frame clip 1602, 1604, 1606. These world fields 1702, 1704, 1706 may be adapted for allowing the user to enter a description of the ingredient shown in the corresponding screen clip 1602, 1604, 1606. In particular embodiments, the ingredients list may, along with the ingredients used to make the mixed drink, also include the tools used to prepare the mixed drink. Once the ingredients have been entered, the user may select the save button 1706 to return to the navigation page 500.

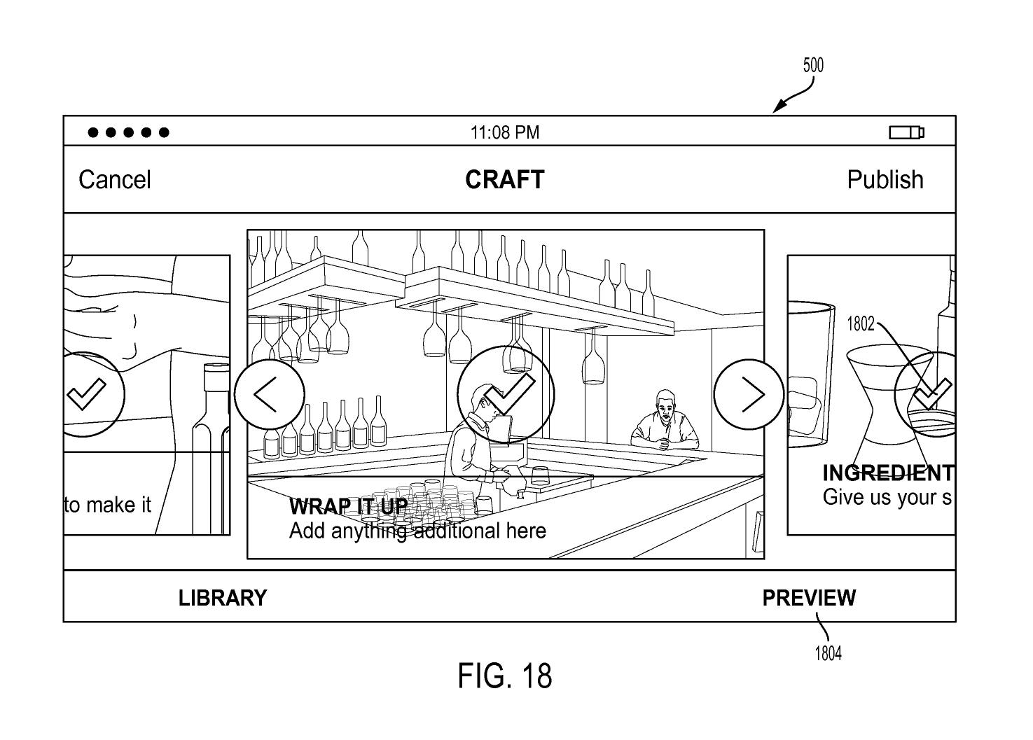

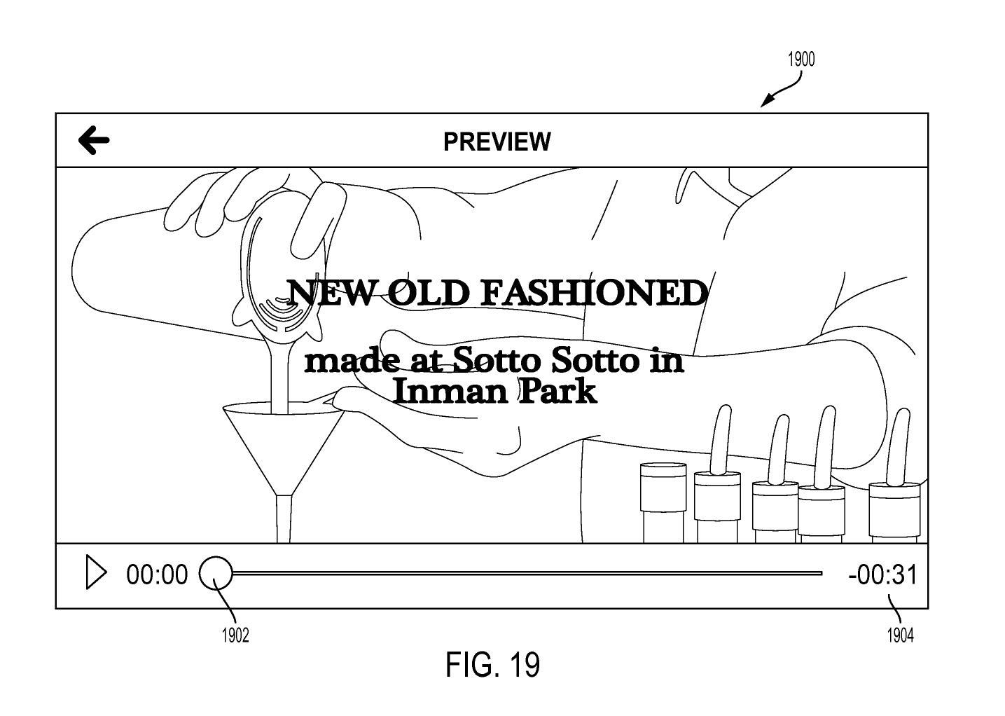

Returning to the navigation page 500, as shown in FIG. 18, shows a fifth check mark 1802 indicating that the ingredient section has been completed. Upon completion of each or some of the sections, the user may select the preview button 1804 to view the video that has been created using the video production application.

Selecting the preview button 1804 of FIG. 18 will direct the user to the preview page 1900 where the user can view the video that has been created. Selecting the preview button 1804 may, in various embodiments, also insert a particular stock image advertisement or video advertisement to the end of the user's video. The user may play the video all the way through. The user may also fast-forward to a particular part of the video using the scroll bar 1902. When viewing the preview page 1900, the user is able to see the total length of the video 1904. Because the scroll bar 1902 may include the length of time of the video, if the user needs to make any further edits, the user will know the exactly how far into the video to make the edits based on where the time indicated by the scroll bar 1902. The preview page 1900 displays the name of the drink and where the drink was made as discussed above in reference to FIG. 6.

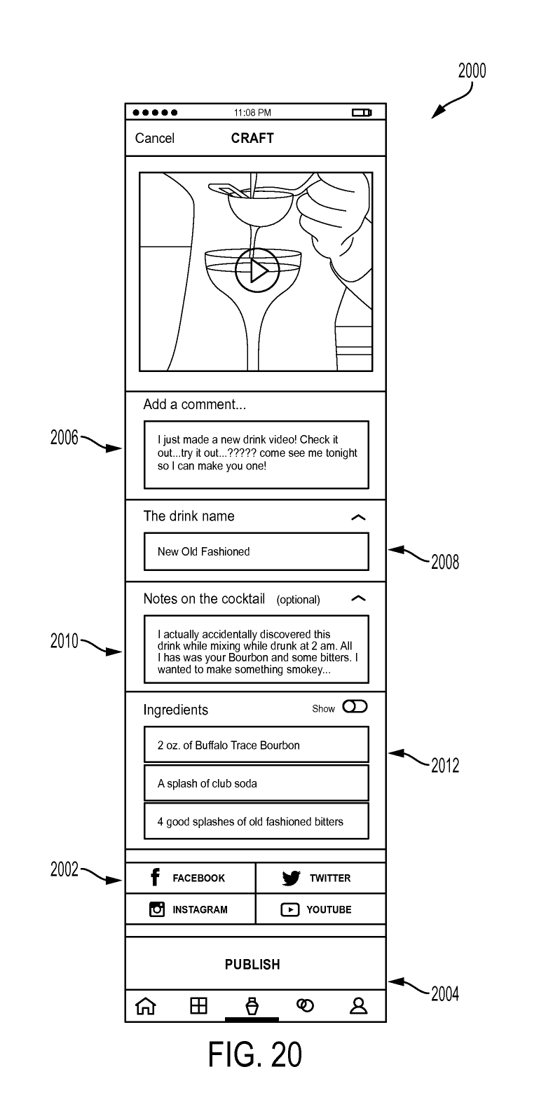

Referring to FIG. 20, in various embodiments, the system may allow the user to upload the video to a social media site 2002 and/or to publish 2004 the video using the publishing page 2000 of the video production application. In publishing the video, the user may include details about the particular mixed drink prepared in the video. Such details may include one or more comments 2006, the name of the mixed drink 2008, notes 2010, and the ingredients and tools to make the mixed drink 2012. The published video may also allow other users to “like” the video and/or make comments about the video.

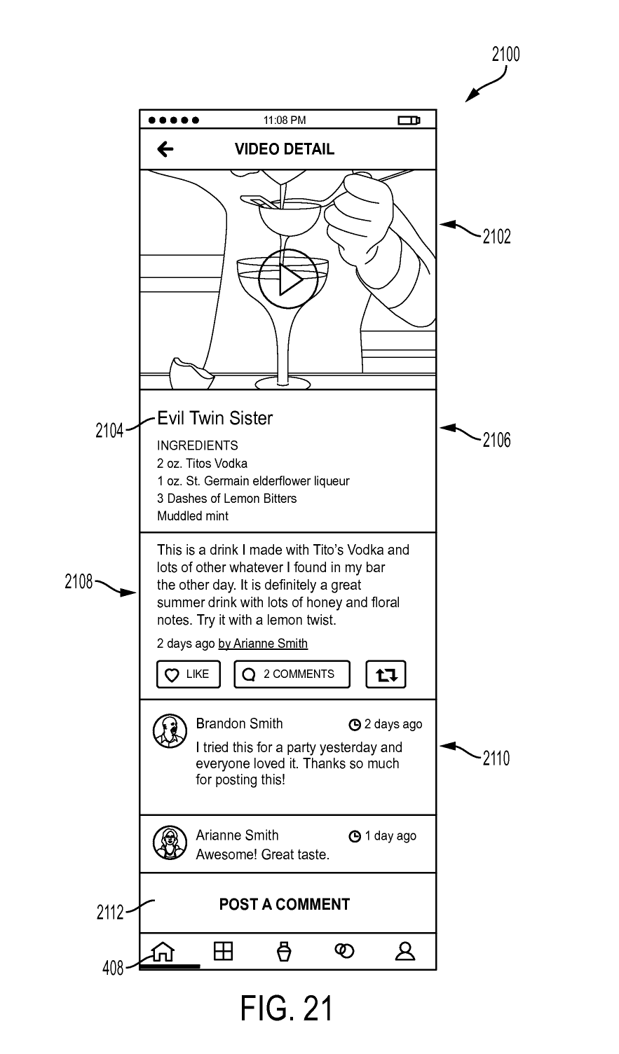

Referring to FIG. 21, the user may select the home button 408 to view other videos that the user and other users have made. This home screen 2100 may also be used as an electronic cocktail menu, as discussed above. In the electronic cocktail menu, the system will display a video showing the drink being made 2102, the name of the drink 2104, the ingredients in the drink 2106, notes about the drink 2108, and comments from other users who have had the drink 2110. The electronic cocktail menu may also allow users to post a comment about the drink by selecting the post a comment button 2112.

### Alternate Embodiment

In an alternate embodiment, the promotional video competition module 300 may facilitate incentivizing an individual to promote one or more brands of a particular consumer product (e.g., automobile tires) via a promotional video competition. Similar to the promotional video competition involving a particular brand of alcohol, a tire manufacturer may create a competition in which users may enter the competition by filming the user test driving an automobile having the particular brand of tires. The video may, for example, include a description of the tire and may include the user “showing off” while driving with the particular brand of tire in order to create organic marketing of the particular brand of tire. As noted above, the makers of the highest rated videos in the competition may receive a prize (e.g., a free or discounted set of tires).

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1.-34. (canceled)

35. A computer-implemented method for allowing a user to produce a finalized video by automatically generating the finalized video on a mobile computing device comprising a camera, a microphone, one or more processors, and a memory, the method comprising:
installing, by the one or more processors, a video production software application on the mobile computing device;
receiving input from a user, by the one or more processors via the video production software application, text for inclusion in the finalized video;
receiving from the user, by the one or more processors via the video production software application, a selection of a font for use in displaying the text;
automatically formatting, by the one or more processors, the text using the font into a formatted text;
automatically selecting, by the one or more processors, a music theme based on the font;
recording, by the one or more processors, using the camera via the video production software application, first raw video footage of an introductory video section;
storing, by the one or more processors, the first raw video footage of the introductory video section the memory;
recording, by the one or more processors, using the camera via the video production software application, second raw video footage of a beverage crafting video section;
automatically speeding up the second raw video footage, by the one or more processors, to generate a sped up beverage crafting video section;
storing, by the one or more processors, the sped up beverage crafting video section in the memory;
recording, by the one or more processors, using the microphone via the video production software application, a voiceover for playing during playback of the sped up beverage crafting video section;
storing, by the one or more processors, the voiceover in the memory;
combining the first raw video footage of the introductory video section and the sped up beverage crafting video section into a single video;
automatically generating, by the one or more processors, the finalized video comprising the single video on the mobile computing device;
automatically inserting, by the one or more processors, the formatted text into the finalized video;
automatically adding, by the one or more processors, the voiceover to the sped up beverage crafting video section in the finalized video; and
storing, by the one or more processors, the finalized video in the memory.

36. The computer-implemented method of claim 35, further comprising:
automatically slowing down, by the one or more processors, a particular portion of the finalized video without input from the user.

37. The computer-implemented method of claim 36, further comprising:
receiving, by the one or more processors, from the user via the video production software application, information regarding one or more ingredients used to make a particular alcoholic beverage;
capturing a screen clip of each of the one or more ingredients from the second raw video footage of the beverage crafting video section;
generating an ingredients list for inclusion in the finalized video that includes the information regarding the one or more ingredients and the screen clip of each of the one or more ingredients; and
adding the generated ingredients list to the finalized video.

38. The computer-implemented method of claim 35, further comprising:
displaying, by the one or more processors, via the video production software application on a display of the mobile computing device, instructions on how to begin recording the introductory video section.

39. The computer-implemented method of claim 35, further comprising:
initiating, at a video competition server by a computing device associated with a competition promoter over the Internet, a video competition;
automatically submitting, by the one or more processors, the finalized video into the video competition; and
transmitting the finalized video from the memory to the video competition server over the Internet.

40. A computer system comprising:
a mobile computing device;
one or more processors;
a memory;
a microphone; and
a camera, wherein the one or more processors are configured for:
installing a video production software application on the mobile computing device;
receiving input, from an individual via the video production software application, of information for use in a finalized video;
automatically formatting a textual representation of the information using the video production software application;
recording, using the camera, via the video production software application, raw video footage in a plurality of video sections;
automatically speeding up one or more of the plurality of video sections to generate a sped up version of the one or more of the plurality of video sections using the video production software application;
automatically combining the plurality of video sections, including the sped up version of the one or more of the plurality of video sections, into a single video using the video production software application;
recording, using the microphone, via the video production software application, one or more voiceovers at normal speed for playback during the sped up version of the one or more of the plurality of video sections in the finalized video;
automatically generating the finalized video comprising the single video, the one or more voiceovers over the sped up version of the one or more of the plurality of video sections, and the formatted textual representation of the information using the video production software application locally on the mobile computing device; and
storing the finalized video in the memory.

41. The computer system of claim 40, wherein:
recording the plurality of video sections comprises:
recording, using the camera, via the video production software application, first raw video footage of an introduction section; and
recording, using the camera, via the video production software application, second raw video footage of a section showing the individual making a particular alcoholic beverage.

42. The computer system of claim 41, wherein:
automatically speeding up one or more of the plurality of video sections comprises automatically speeding up the second raw video footage.

43. The computer system of claim 42, wherein:
the one or more processors are further configured for:
receiving, from the individual a selection of a particular font; and
automatically formatting the textual representation of the information comprises automatically formatting the textual representation in the particular font.

44. The computer system of claim 43, wherein:
the information comprises a name of the particular alcoholic beverage; and
automatically generating the finalized video comprises inserting the textual representation of the name of the particular alcoholic beverage at a beginning of the single video.

45. The computer system of claim 44, wherein:
the one or more processors are further configured for:
automatically selecting a music theme for the finalized video based on the selected particular font; and
automatically generating the finalized video comprises automatically adding the music theme to the finalized video.

46. The computer system of claim 45, wherein:
the one or more processors are further configured for:
receiving, from the individual via the video production software application, information regarding one or more ingredients used to make the particular alcoholic beverage;
capturing a screen clip of each of the one or more ingredients from the section of the single video showing the individual making the particular alcoholic beverage;
generating an ingredients list for inclusion in the finalized video that includes the information regarding the one or more ingredients and the screen clip of each of the one or more ingredients; and
automatically generating the finalized video comprises automatically adding the generated ingredients list to the finalized video.

47. The computer system of claim 46, wherein:
the one or more processors are further configured for automatically slowing down a particular portion of the finalized video without input from the user.

48. The computer system of claim 46, wherein:
the one or more processors are further configured for:
receiving, from the individual via the video production software application, an indication to slow down a particular portion of the finalized video during playback of the finalized video; and
in response to the indication, automatically slowing down the particular portion of the finalized video.

49. The computer system of claim 48, wherein:
the particular portion of the finalized video comprises a section of the sped up version of the one or more of the plurality of video sections.

50. The computer system of claim 49, wherein:
the one or more processors are further configured for:
generating an electronic cocktail menu comprising the finalized video for the particular alcoholic beverage;
receiving a first video showing a bartender preparing a first particular alcoholic beverage, a second video showing a bartender preparing a second particular alcoholic beverage, and a third video showing a bartender preparing a third particular alcoholic beverage; and
assembling the first, second and third videos into the electronic cocktail menu.

51. The computer-system of claim 40, wherein the one or more processor are configured to allow the individual to produce the finalized video.

52. A computer implemented method of automatically combining different sections of footage into a single, cohesive finalized video entirely on a mobile computing device, the method comprising:
providing, by one or more processors, a video production software application for installation on the mobile computing device;
installing, by one or more processors, the video production software application on a mobile computing device associated with an individual and comprising a camera, a microphone, and a memory;
receiving input, by one or more processors, from the individual via the video production software application, of information for use in the finalized video;
automatically formatting, by one or more processors, a textual representation of the information;
recording, by one or more processors, using the camera, via the video production software application, raw video footage in a plurality of video sections;
automatically speeding up, by one or more processors, one or more of the plurality of video sections to generate a sped up version of the one or more of the plurality of video sections;
automatically combining, by one or more processors, the plurality of video sections, including the sped up version of the one or more of the plurality of video sections, into a single video;
recording, by one or more processors, using the microphone, via the video production software application, one or more voiceovers at normal speed for playback during the sped up version of the one or more of the plurality of video sections in the finalized video;
automatically generating, by one or more processors, the finalized video comprising the single video, the one or more voiceovers over the sped up version of the one or more of the plurality of video sections, and the formatted textual representation of the information entirely on the mobile computing device; and
storing, by one or more processors, the finalized video in memory.

53. The computer-implemented method of claim 52, further comprising:
receiving, by one or more processors, from the individual, a selection of a particular font; and
automatically selecting a music theme, by one or more processors, for the finalized video based on the selected particular font, wherein:
automatically formatting the textual representation of the information comprises automatically formatting the textual representation in the particular font; and
automatically generating the finalized video comprises automatically adding the music theme to the finalized video.

54. The computer-implemented method of claim 52, further comprising:
automatically slowing down, by the one or more processors, a particular portion of the finalized video without input from the individual.

55. The computer-implemented method of claim 54, wherein:
the particular portion of the finalized video comprises the sped up version of the one or more of the plurality of video sections.

56. The computer-implemented method of claim 55, further comprising:
allowing, by the one or more processors, the individual to produce the finalized video using the video production software application.
